(19) United States
(12) Patent Application Publication
(10) Pub. No.: US 2025/0064684 A1
(43) Pub. Date: Feb. 27, 2025

(54) INFANT FEEDING ASSEMBLY AND METHOD OF STERILISING

(71) Applicant: Mayborn (UK) Limited, Newcastle Upon Tyne (GB)

(72) Inventors: Joshua Hume, Newcastle Upon Tyne (GB); Nicholas Cudworth, Newcastle Upon Tyne (GB); Simon Lewis Bilton, Newcastle Upon Tyne (GB); Matthew Scott Kettyle, Newcastle Upon Tyne (GB)

(21) Appl. No.: 18/708,476

(22) PCT Filed: Nov. 11, 2022
(86) PCT No.: PCT/GB2022/052874

§ 371 Date: May 8, 2024

(30) Foreign Application Priority Data
Nov. 12, 2021 (GB) 2116378.7

(51) Int. Cl. A61J 11/04; A61J 11/00

(52) U.S. Cl. CPC A61J 11/045; A61J 11/008

(57) ABSTRACT

The present invention relates to an infant feeding assembly, in particular an assembly which is sterilisable by steam generated within a container to which the assembly is mounted. The assembly includes a securing member for mounting an infant feeding nipple to a mouth of a container, and a surface including a cover contacting portion for selectively mounting a cover to the assembly. The assembly further includes a fluid flow path configured such that, when the securing member mounts the infant feeding nipple to the container in use, the container is fluidly connected to the surface. A method of sterilising the infant feeding assembly is also disclosed.

The present invention relates to an infant feeding assembly, in particular an assembly which is sterilisable by steam generated within a container of the assembly. A method of sterilising an infant feeding assembly is also disclosed.

### INTRODUCTION

A wide range of infant feeding assemblies are known so as to provide parents and carers with the means to feed babies and infants. Assemblies include a container or bottle for holding the liquid, typically milk such as expressed breast milk or formula. A nipple, also known as a teat, is mounted to the container to enable the infant to suckle the liquid from the container. Such infant feeding assemblies are designed to be used by infants aged two years or younger, and may commonly be used by even new-born infants. Hygienic preparation of both the liquid as well as the infant feeding assemblies themselves is therefore essential.

A common technique to ensure adequate hygiene of the assemblies is to sterilise the components using steam. Providing direct contact of steam with the surfaces of the components for a sufficient period of time, perhaps several minutes or more, ensures effective sterilisation of their exposed surfaces.

Steam may be generated by loading the components into a larger vessel with a small amount of water. A heating element within the vessel may be activated so as to heat the water and generate steam which circulates within the vessel. Alternatively, vessels without a heating element may be placed in a microwave oven which is operated to provide microwave energy to heat the water and generate steam. Regardless of how it is generated, steam in the vessel contacts and sterilises the exposed surfaces of the components loaded within.

One drawback of known apparatus is that, once sterilised, components of an infant feeding assembly must be removed from the sterilising vessel before use. Removing the components from the sterilising vessel risks contamination from exposure to the open air. A further problem is that sterilised components must be manually reassembled, requiring the user to hold the components and risking inadvertent contamination of the sterilised surfaces. In either case, the user cannot reliably ensure avoidance of contamination and may proceed to feed an infant from a non-hygienic assembly.

A further problem is that sterilising dissembled components requires the use of an additional vessel, necessitating use of supplementary equipment. Also, the additional vessel will have a larger, sometimes significantly larger, volume than the infant feeding assembly. Thus, sterilisation requires generating excess steam in order to circulate steam within the whole volume of the vessel and ensure contact with all exposed surfaces. Sterilisation of individual infant feeding assemblies is known but the apparatus still requires reassembly post-sterilisation, thereby introducing the risk of contamination as set out above.

Accordingly, it would be useful to provide an infant feeding assembly which may be sterilised in a fully, or a substantially fully, assembled format. In particular, it would be useful to provide an assembly which ensures that sterilised surfaces are not contactable or otherwise exposed to contamination before the assembly is used to feed an infant. Yet further, it would be useful to provide an assembly which allows the user to reliably sterilise and then store a hygienic infant feeding assembly with reduced risk of contamination.

Further, it would also be useful to provide an infant feeding assembly and a method of sterilising the assembly which provides efficient steam sterilisation. In particular, it would be useful to provide an assembly which requires a reduced volume of steam to effectively provide a hygienic infant feeding assembly. It would also be useful to provide an assembly which is suitable for more efficient microwave steam sterilisation, that is, provide an assembly which can be sterilised using reduced electrical power or in a shorter period of time.

### SUMMARY OF THE INVENTION

The invention is set out in the appended claims.

According to an aspect of the invention, there is provided an infant feeding assembly, the assembly including:
a securing member for mounting an infant feeding nipple to a mouth of a container;
and a surface comprising a cover contacting portion for selectively mounting a cover to the assembly;
wherein the assembly further comprises a fluid flow path configured such that, when the securing member mounts the infant feeding nipple to the container in use, the container is fluidly connected to the surface.

According to another aspect of the invention, there is provided a collar for an infant feeding assembly, the collar including:
an inner surface defining an engagement portion for mounting an infant feeding nipple to a mouth of a container;
an outer surface defining a cover contact portion;
an opening for receiving an infant feeding nipple; and
a fluid flow path between the engagement portion and the cover contact portion,
wherein the fluid flow path is spaced apart from the opening.

Aptly, the fluid flow path is selectively closable.

Aptly, the assembly is adapted to be selectively moveable relative to the container between a first position, in which the fluid flow path is open, and a second position, in which the fluid flow path is closed.

Aptly, when the assembly is in the second position, the assembly sealingly engages the mouth of the container. More aptly, when the assembly is in the second position, the nipple, typically a sealing flange of the nipple, sealingly engages the mouth of the container.

Aptly, when the infant feeding assembly includes a vent assembly.

More aptly, the vent assembly is mounted to the mouth of the container so that, in the second position, the nipple sealingly engages with the vent assembly. Typically, a sealing flange of the nipple engages with the vent assembly. That is, in the second position the nipple, typically a sealing flange of the nipple, urges a vent assembly into sealing engagement with the mouth of the container. The mouth of the container is thereby sealed by the vent assembly sandwiched between the nipple and the mouth by the securing member.

Aptly, wherein a portion of the fluid flow path is formed in at least one of the securing member and the nipple.

Aptly, a portion of the fluid flow path is provided as a channel along a surface of at least one of the securing member or the nipple.

Aptly, a portion of the fluid flow path is provided as a conduit extending though at least one of the securing member or the nipple.

Aptly, a portion of the fluid flow path is provided at an interface of the securing member and the nipple.

Aptly, the surface includes an opening forming an outlet to the fluid flow path.

Aptly, the opening is an elongated slot.

Aptly, the opening includes a plurality of openings arranged around the surface, the plurality of openings forming a plurality of outlets to the fluid flow path.

Aptly, the securing member includes a screw thread adapted to matingly engage a corresponding screw thread on the container.

Aptly, the infant feeding assembly further includes an infant nipple.

Aptly, the infant feeding assembly further includes a cover.

Aptly, the cover comprises an internal recess, the internal recess defining a volume sufficient to receive at least a nipple of an infant feeding assembly.

Aptly, when the cover is mounted to the cover contacting portion, the fluid flow path of the assembly is fluidly connected to the internal recess.

Aptly, the nipple includes a feeding fluid flow path, wherein the feeding fluid flow path is provided through the nipple, and is configured to enable an infant to feed from the infant feeding assembly. Optionally, the feeding fluid path is closed when the cover is mounted to the cover contacting portion. That is, an inner surface element in the internal recess of the cover sealingly engages and closes the feeding fluid flow path when the cover is mounted within the assembly.

Aptly, the nipple is integrally formed with the securing member.

Aptly, the infant feeding assembly further includes a container mounted to the securing member.

According to a further aspect of the invention, there is provided a method of sterilising an infant feeding assembly wherein the method includes the steps of:
using a securing member to mount an infant feeding nipple to a mouth of a container;
removably mounting a cover to a cover contacting portion on a surface of the assembly, wherein the cover includes an internal recess in which the infant feeding nipple is received;
generating steam within the container; and
using a fluid flow path to convey the steam from the mouth of the container to the internal recess.

Aptly, the method includes a further step of generating steam for a predetermined time interval and then selectively closing the fluid flow path.

Aptly, the step of closing the fluid flow path includes moving the infant feeding assembly relative to the container from a first position, in which the fluid flow path is open to a second position, in which the fluid flow path is closed.

Aptly, the step of closing the fluid flow path further includes the securing member urging the nipple into sealing engagement with the mouth of the container.

According to a yet further aspect of the invention, there is provided a method including the steps of:
providing an infant feeding assembly, the assembly including:
   a securing member for mounting an infant feeding nipple to a mouth of
   a container;
   a surface including a cover contacting portion for selectively mounting a cover to the assembly; and
   a flow path between an inner surface portion of the securing member and the surface;
mounting an infant feeding nipple to a mouth of a container;
mounting a cover on the cover contacting portion including an internal recess so that the nipple is received into the internal recess;
generating steam within the container; and
conveying the steam from the mouth of the container to the internal recess via the flow path.

Aptly, a method includes arranging a vent assembly in the mouth of the container. In such a method the step of closing the fluid flow path further includes the securing member urging the nipple, typically a sealing flange of the nipple, into sealing engagement with the vent assembly. That is, closing the fluid flow path includes moving the securing member to sandwich the vent assembly between the nipple and the mouth of the container.

Certain examples provide an infant feeding assembly which may be sterilised and then stored or used without exposure to possible contamination.

Certain examples provide an infant feeding assembly which is sterilisable without requiring reassembly of component parts. Particularly, the assembly may be sterilised in a fully, or a substantially fully, assembled format.

Certain examples provide an infant feeding assembly that may be sterilised in a format which allows the user to seal the assembly from contamination. Additionally, certain examples provide a convenient way to store an infant feeding assembly in a sealed hygienic state.

Certain examples provide an infant feeding assembly which may be more efficiently sterilised. Additionally, an assembly may be sterilised using a reduced volume of water, or without providing excessive steam.

Certain examples provide an infant feeding assembly which can be sterilised without additional equipment.

It will be appreciated that any of the features described above in relation to one aspect of the invention may apply other aspects of the invention. That is, any infant feeding assembly features described above may be combined with any other feature of the assembly, or with any of the methods of sterilising disclosed herein.

### BRIEF DESCRIPTION OF THE DRAWINGS

Embodiments of the invention are now described, by way of example only, hereinafter with reference to the accompanying drawings, in which:

FIG. 1 shows an infant feeding assembly (a) without a cover and (b) with a cover mounted thereto, of a configuration according to the prior art;

FIG. 2 shows (a) a perspective view and (b) a cross-sectional view along axis A-A, of a securing member of an example infant feeding assembly

FIG. 3 shows an expanded perspective view of an infant feeding assembly of an example;

FIG. 4 shows a cross-sectional side view of an infant feeding assembly of FIG. 3 in a first position;

FIG. 5 shows a cross-sectional side view of the assembly of FIG. 3 in a second position;

FIG. 6 shows a cross-sectional side view of another example of an infant feeding assembly in a first position;

FIG. 7 shows a cross-sectional side view of the assembly of FIG. 6 in a second position

FIG. 8 shows an expanded perspective view of a further example infant feeding assembly;

FIG. 9 shows a cross-sectional side view of the infant feeding assembly of FIG. 8 in a first position; and

FIG. 10 shows a cross-sectional side view of the infant feeding assembly of FIG. 8 in a second position.

In the drawings, like reference numerals refer to like parts.

### DETAILED DESCRIPTION

Certain terminology is used in the following description for convenience only and is not limiting. The words ‘inner’ and ‘outer’ refer to directions toward and away from, respectively, a designated centreline or a geometric centre of an element being described (e.g. central axis), the particular meaning being readily apparent from the context of the description.

Further, as used herein, the terms ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

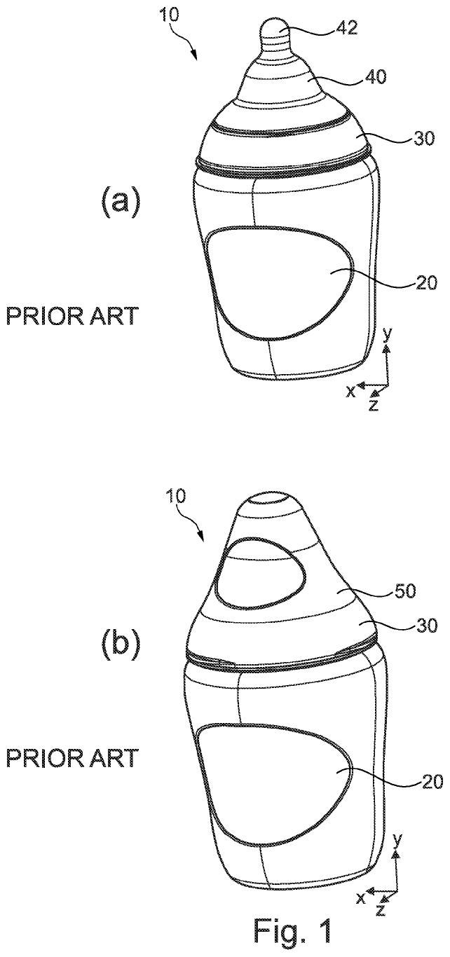

Referring now to FIGS. 1a) and b) there is shown infant feeding assembly 10 of a general configuration as known in the prior art. The assembly includes a container 20, in this case an infant feeding bottle. The assembly includes a securing member 30 and a nipple 40 mounted thereto so that the teat portion 42 of the nipple 40 is arranged to project away from the securing member 30. The securing member 30 is annular with a central orifice extending therethrough to which the nipple 40 is mounted.

The securing member 30 is adapted for selectively mounting a cover 50 of the infant feeding assembly 10.

The securing member 30 is engaged with a container 20 so as to mount the nipple 40 to the mouth of the container 20. The securing member 30 is removable engaged with the container 20 so that, in use, a user may remove or demount the container 20 from the infant feeding assembly 10 and pour liquid inside ready for feeding to an infant.

The teat 40 is suitably shaped so to be comfortably received in an infant's mouth and includes an opening provided through the teat portion 42 which dispenses liquid during feeding.

In the example shown in FIGS. 1a) and 1b) the infant feeding assembly 10 must be dissembled for cleaning and sterilisation. Thus, each of the container 20, nipple 40, securing member 30 and cover 50 are separately loaded into a sterilising vessel, for example using sterilisation methods described above, so as to sterilise their exposed surfaces. Consequently, this infant feeding assembly 10 suffers from the drawbacks and problems noted above.

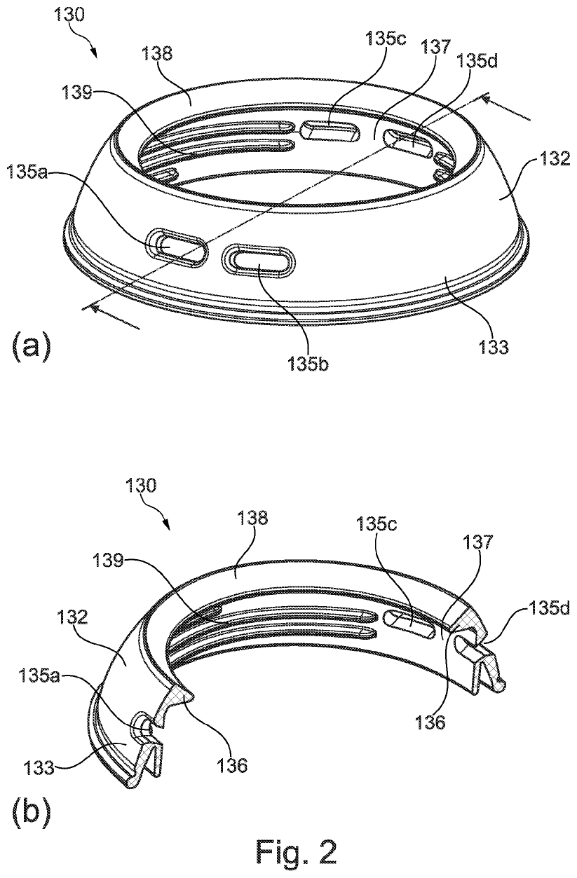

Referring now to FIGS. 2a) and 2b) there is shown a securing member 130 of an infant feeding assembly for mounting an infant feeding nipple to a mouth of a container.

The securing member 130 of the assembly includes a surface 132 with a cover contacting portion 133 for selectively mounting a cover to the assembly. That is the cover contacting portion 133 is adapted to cooperate with a portion of the cover so as to removably mount the cover to the assembly securing member 130.

The securing member 130 of the assembly further includes a fluid flow path configured such that, when the securing member 130 mounts the infant feeding nipple to the container in use, the container is fluidly connected to the surface 132. That is, the assembly provides fluid flow path so that, during sterilisation, a fluid circulating within the container, for example steam, is able to escape from inside the container.

In this way, the steam generated in the container is available not only to contact and sterilise the exposed inner surfaces of the container and the infant feeding assembly, but also is able to contact and sterilise surfaces outside the container.

The fluid flow path is formed in the securing member 130. In particular, the fluid flow path is formed as a conduit extending through the securing member 130. That is a conduit is formed through the securing member 130 so as to provide a fluid connection between an inner surface portion 137 and the surface 132, that is the surface 132 including the cover contacting portion 133.

The conduit 135 extends radially from the inner surface portion 137 to the surface 132. That is, the conduit 135 extends radially outward from the inner surface portion 137 to the surface 132.

In the example shown, the surface 132 includes an opening 135a which forms an outlet to the fluid flow path. The opening 135a is formed as an elongated slot. The elongated slot is arranged to extend circumferentially around the surface 133 of the securing member 130.

The opening 135a is provided as one of a plurality of openings 135a-d arranged around the surface 133. The example shown in FIG. 2 includes a first pair of slots 135a, 135b and a second pair of slots 135c, 135d. The first pair of slots 135a, 135b is spaced from the second pair of slots 135c, 135d. That is the first pair of slots 135a, 135b is arranged in an opposing orientation to the second pair of slots 135c, 135d on the surface 133.

Each opening 135a-d forms an outlet to the fluid flow path. In this way, the fluid flow path includes outlets spaced around the securing member 130. By providing spaced outlets, the assembly may more evenly distribute steam from the container around the securing member 130.

The securing member 130 includes a radial projection 136 adapted to matingly engage with a nipple 140. In the example shown, the radial projection 136 is annular and extends radially inward from the inner surface portion 137. In this way, the radial projection 136 is adapted to be received by a corresponding annular recess in the nipple 140 to matingly engage therein.

The radial projection 136 includes a support surface 138. The support surface 138 is angled so that, when the securing member 130 is mounted to a container then the support surface 138 faces away from the container. In this way, the support surface 138 is angled upwards to support the nipple 140 mounted to the securing member 130.

The securing member 130 includes a screw thread 139. The screw thread 139 is adapted to matingly engage a corresponding screw thread on the container. In this way, the screw threads provide an engagement means to mount the securing member 130 to the container. The securing member 130 is thereby removably mountable to the container. Thus, the infant feeding assembly includes a removably mountable container.

In the example shown, the screw thread 139 is provided proximal to the inner surface portion 137. However, the screw thread 139, or indeed any other suitable engagement means for mounting the infant feeding assembly to a container, is not limited to this position and may be provided any suitable arrangement on the infant feeding assembly.

The fluid flow path is provided as a conduit on the inner surface portion 137. That is, the fluid flow path is configured so to extend from the inner surface portion 137. The fluid flow path is configured to extend from a position on the infant feeding assembly proximal to the engagement means for mounting the infant feeding assembly to a container.

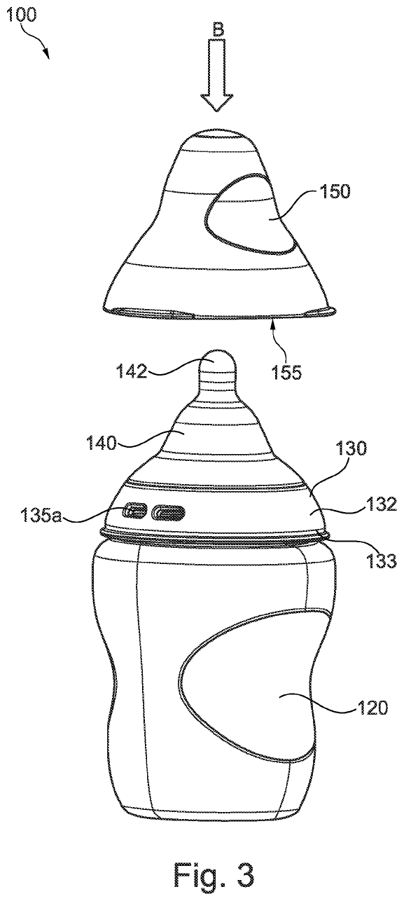

Referring now to FIG. 3 there is shown an infant feeding assembly 100 including the securing member 130 as described with reference to FIG. 2. The securing member 130 is mounted to a container 120 so that the teat portion of the nipple 140 is arranged to project away from the container 120.

With the nipple 140 mounted to the securing member 130, the surface 132 of the securing member 130 is provided radially outward from the nipple 140. The surface 132 is provided between the nipple 140 and the container 120. In this way, the opening 135a is provided radially outward from the nipple 140. That is, an outlet to the fluid flow path is provided radially outward from the nipple 140. Stated alternatively, the opening 135a is provided between the nipple 140 and the container 120. That is, an outlet of the fluid flow path is provided between the nipple 140 and container 120.

The nipple 140 includes an aperture extending through the wall of the nipple 140. The aperture is provided in the teat portion 142 of the nipple 140 so as to be located within an infant's mouth as they feed from the infant feeding assembly 100. The nipple 140 thereby includes a feeding fluid flow path, configured to enable an infant to feed from the infant feeding assembly 100.

The feeding fluid flow path may be provided by a single aperture or plurality of apertures extending through the wall of the nipple 140. The aperture, or apertures, may be sized so as to provide an appropriate flow rate of liquid out of the nipple 140 during feeding. In other words, the flow rate of liquid out of the nipple 140 may be selected according to the needs of the infant.

The nipple 140 is removably mounted to the securing member 130. That is, the nipple 140 is provided as a separate part which can be mounted and demounted to the securing member 130 by the user.

Alternatively, the nipple may be integrally formed with the securing member. That is, the nipple and securing member are formed as a unitary part so that the number of component parts of the infant feeding assembly 100 are reduced.

Also shown in FIG. 3 is a cover 150 demounted from the securing member 130. The cover 150 includes an internal recess 155. The internal recess 155 defines a volume sufficient to receive the nipple 140 of the infant feeding assembly 100. In this way, when the cover 150 is mounted to the cover contacting portion 133 of the securing member 130 the cover 150 encloses the nipple 140.

The cover 150 is mounted to the cover contacting portion 133 by moving the cover 150 toward the assembly as shown by the arrow B. An engaging portion of the cover 150 provided proximal to perimeter of the internal recess 155 engages the cover contacting portion 133. In this way the cover 150 is mounted to the securing member 130 by engagement between the engaging portion and the cover contacting portion 133. In the example shown, the cover 150 is mounted to the securing member 130 by an interference fit.

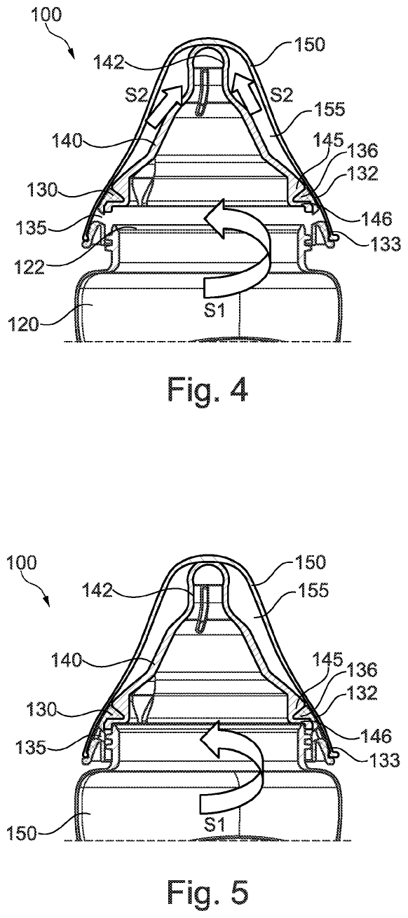

Referring now to FIG. 4, there is shown a cross-sectional view of infant feeding assembly 100 of FIG. 3 with its cover 150 mounted to the securing member 130. The assembly is shown in a first position. Thus, the securing member 130 is arranged to mount the infant feeding nipple 140 to the mouth 122 of the container 120 so that a fluid flow path is provided between the container 120 and the surface 132.

The cover 150 of the infant feeding assembly 100 is mounted to the cover contacting portion 133 so that the cover 150 encloses openings 135a-d provided on the surface 132. The cover 150 encloses the openings 135a-d without blocking the fluid flow path. In this way, with the cover 150 mounted to the securing member 130, a fluid flow path is provided from the mouth 122 of the container 120 to the internal recess 155 of the cover 150. The mouth 122 of the container 120 is thus fluidly connected to the internal recess 155 of the cover 150.

The cover 150 may be mounted to the securing member 130 with a substantially fluid-tight seal. The cover 150 may be mounted to the securing member 130 so as to require a predetermined disengagement force. In these ways the cover 150 engaged with the securing member 130 so as to withstand increased temperatures provided by steam circulating in the cover 150.

Also shown in FIG. 4, the radial projection 136 of the securing member 130 is matingly engaged in an annular recess of the nipple 140. The annular recess is also known as an undercut.

The annular recess separates a sealing flange 146 of the nipple 140 from a nipple base portion 145. With the securing member 130 mounted to the nipple 140, the support surface 138 engages the nipple base portion 145. The support surface 138 thereby conveniently provides structural rigidity to the nipple base portion 145, even where the nipple is moulded from a relatively pliable, or deformable material.

In the first position, as shown in FIG. 4, the assembly is ready for use. That is the assembly is ready for sterilising by steam generated within its container 120.

To sterilise the infant feeding assembly 100, a user deposits an amount of water in the container 120 sufficient to generate enough steam to sterilise all exposed surfaces of the infant feeding assembly 100. The container 120 is mounted within the assembly 100 in the first position and placed in a microwave oven which is operated to heat the water and generate steam within the container 120.

The generated steam circulates within the container 120 and the internal cavity of the nipple 140, as indicated by arrow S1. In this way, the steam sterilises all exposed internal surfaces of the assembly, that is internal surfaces of the securing member 130, nipple 140 and container 120. Thus, the steam sterilises the surfaces of the infant feeding assembly 100 which are contactable by liquid stored or deposited in the assembly 100 prior to feeding.

The generated steam is conveyed by the fluid flow path from the container 120 to the internal recess 155 of the cover 150, as indicated by arrows S2. The steam circulates within the internal recess 155. In this way, the steam sterilises exposed external surfaces of the nipple 140 and securing member 130. Thus, the steam sterilises the surfaces of the infant feeding assembly 100 which are contactable by the infant's mouth during feeding.

The steam also sterilises the inner surface of the cover 150, thereby ensuring the nipple 140 may be held in a sterile recess 155 for as long as the cover 150 remains mounted to the cover contacting portion 133.

The microwave oven is operated to generate steam for several minutes, for example in the range 3 to 10 minutes. The prolonged contact of the steam with surfaces provides effective sterilisation of all critical surfaces of the infant feeding assembly 100 and the container 120.

When operation of the microwave oven ceases, the infant feeding assembly 100 may be allowed to cool until easily handled by a user.

The fluid flow path in the infant feeding assembly 100 is selectively closable. That is the fluid flow path may be closed so as to fluidly isolate the container 120 from the surface 132. The container 120 may be selectively fluidly isolated from the internal recess 155 of the cover 150.

The infant feeding assembly 100 is adapted to be selectively moveable relative to the container 120 between the first position, in which the fluid flow path is open, and a second position, in which the fluid flow path is closed.

In particular, the infant feeding assembly 100 is rotatable relative to its container 120 due to the mating screw threads. Consequently, rotation of the infant feeding assembly 100 relative to its container 120 moves the infant feeding assembly 100 axially relative to container 120. In this way, rotation of the infant feeding assembly 100 in a first direction moves the infant feeding assembly to the second position.

Rotation brings the assembly into a sealing engagement with the mouth 122 of the container 120. In this way, the mouth 122 of the container 120 is sealed by a surface of the infant feeding assembly 100 so that nipple 140 is fluidly connected to the container 120 and the fluid flow path is closed.

Referring now to FIG. 5, the assembly of FIG. 4 is shown in a second position. The infant feeding assembly 100 is sealingly engaged with the mouth 122 of its container 120 and the fluid flow path is closed.

Selectively moving the infant feeding assembly 100 from the first position to the second position urges the infant feeding assembly 100 towards its container 120. In the example shown in FIG. 5, the infant feeding assembly 100 is arranged so that a sealing flange 146 of the nipple 140 is disposed on the underside of the securing member 130. In this way, moving the infant feeding assembly 100 from the first position to the second position urges the nipple 140 into sealing engagement with the mouth of the container 120. In the example shown, in second position, the sealing flange 146 is urged against the mouth of the container 120, thereby forming the fluid-tight seal.

If the user is to store the infant feeding assembly 100 in a sterile, hygienic state then the assembly may be moved to the second position immediately after sterilisation is complete. Due to the position of the fluid flow path, the user can move the infant feeding assembly 100 to the second position by simply rotating the infant feeding assembly 100 relative to the container 120. Thus, the apparatus can stored in a hygienic format without substantially reassembly, or without the user exposing or contacting the sterile surface 132.

When the infant feeding assembly 100 is to be used to feed a child, the user can demount the securing member 130, the nipple 140 and the cover 150 from the container 120 and deposit liquid into the container 120 in the usual manner.

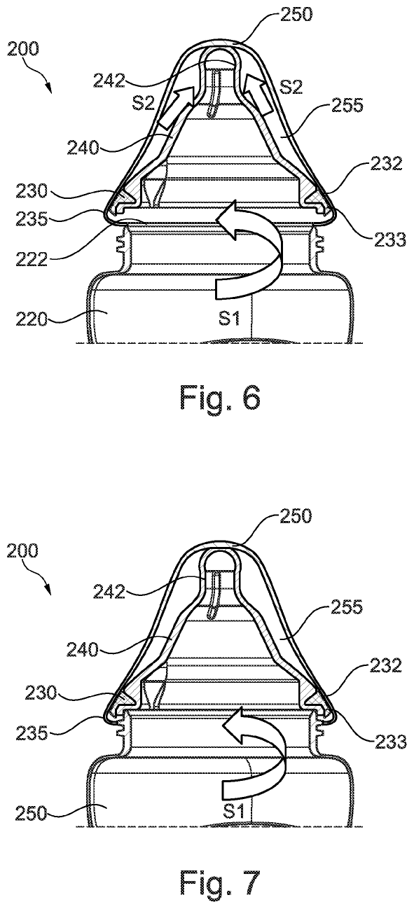

Referring now to FIGS. 6 and 7, there is shown a further example infant feeding assembly 200 for mounting an infant feeding nipple to the mouth of a container. Where the features are the same as a previous example, the reference numbers are the same, other than the initial digit is a “2”. The assembly is substantially the same as the example of FIGS. 3 to 5 except that the cover 250 includes a spacer member 235.

Referring in particular to FIG. 6, the infant feeding assembly 200 is shown in a first position.

The assembly 200 includes a securing member 230 for mounting an infant feeding nipple 240 to the assembly. The securing member 230 mounts the nipple 240 to a container 250 so that the teat portion 240 is arranged to project away from the container 220.

In the example, a radial projection of the securing member 230 matingly engages with a corresponding annular recess in the nipple 240 in same manner as the example of FIGS. 3 to 5. Correspondingly, the support surface of the radial projection engages the nipple base portion of the nipple 240.

The securing member 230 also includes cover contacting position 233 provided on a surface 232 thereof.

A cover 250 is mounted to the cover contacting portion. The cover 250 includes an internal recess 255 for receiving the infant feeding nipple 240.

The cover 250 includes a spacer member 235 for selectively mounting the assembly to the container 220. In the example shown, the spacer member 235 is provided as an annular projection extending around the cover 250.

In the example shown in FIG. 6, the spacer member 235 is configured to extend below the securing member 230. In this way, the spacer member 235 is arranged to contact the mouth 222 of the container 220 as the assembly 200 is brought into engagement with the container 220. The cover 250 is mounted to the container 220 so as to enclose the mouth 222 of the container 220.

With the spacer member 235 mounted to the container 220, the assembly 200 forms a fluid flow path configured such that the container 220 is fluidly connected to the internal recess 255. In particular a fluid flow path is formed between the spacer member 235 and the securing member 230.

The assembly 200 of FIG. 6 is provided in a first position. In the first position, the assembly 200 is ready for use. That is the assembly is ready for sterilising by steam generated within its container 220.

To sterilise the assembly, a user deposits water in the container 220 and generates steam from the water using a microwave oven as explained above in reference to FIG. 4.

The generated steam circulates within the container 220 and the internal cavity of the nipple 240, as indicated by arrow S1. In this way, the steam sterilises all exposed internal surfaces of the assembly, that is internal surfaces of the securing member 230, nipple 240 and container 220. Thus, the steam sterilises the surfaces of the infant feeding assembly 200 which are contactable by liquid stored or deposited in the assembly 200 prior to feeding.

The generated steam is conveyed by the fluid flow path from the container 120 to the internal recess 255 of the cover 250, as indicated by arrows S2. The steam is conveyed by the fluid flow path around the securing member 230 by the spacer member 235 of the cover 250.

The steam circulates within the internal recess 255. In this way, the steam sterilises exposed external surfaces of the nipple 240 and securing member 230. Thus, the steam sterilises the surfaces of the infant feeding assembly 200 which are contactable by the infant's mouth during feeding.

The steam also sterilises the inner surface of the cover 250, thereby ensuring the nipple 240 may be held in a sterile recess 255 for as long as the cover 250 remains mounted to the cover contacting portion 233.

When operation of the microwave oven ceases, the infant feeding assembly 100 may be allowed to cool until easily handled by a user.

Referring in particular to FIG. 7, the infant feeding assembly 200 is shown in a second position.

The infant feeding assembly 200 is adapted to be selectively moveable relative to the container 220 between the first position, in which the fluid flow path is open, and a second position, in which the fluid flow path is closed.

In particular, movement of the securing member 230 relative to the container 220 allows the securing member 230 to be mounted directly to the container 220. That is, assembly is mounted to the container 220 via the securing member instead of the spacer member 235.

In this way, the assembly is configured so that in moving from the first position to the second position, the spacer member 235 is disengaged or demounted from the mouth 222 of the container 220.

At least the spacer member 235 of the cover 250 may be resiliently deformable. In this way, actuation of the cover 250, for example by applying a pressure to diametrically opposed portions of the spacer member 235 may move the securing member 230 relative to the cover 250. In this way, the assembly may be readily moved the second position so as to hygienically seal the feeding bottle assembly until the assembly is used to feed an infant.

Optionally, the securing member 230 may include engagement means (not shown) such as a screw thread of the type described above in reference to FIG. 2. In this way, once in the second position, the assembly may be more reliably secured to the container 200.

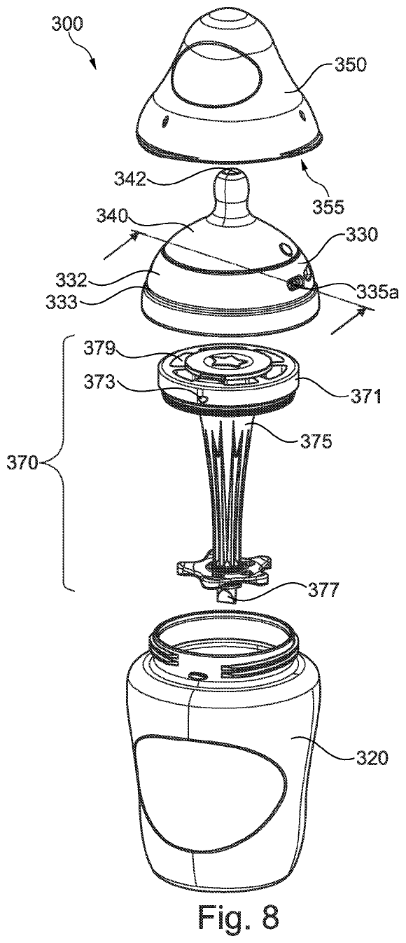

Referring now to FIGS. 8 to 10, there is shown a further example infant feeding assembly 300 for mounting an infant feeding nipple to the mouth of a container. Where the features are the same as a previous example, the reference numbers are the same, other than the initial digit is a “3”. The assembly is substantially the same as the example of FIGS. 3 to 5 except that the assembly includes a venting member 370.

Referring in particular to FIG. 8, the securing member 330 is engaged with a nipple 340 so that the teat portion of the nipple 340 is arranged to project away from a container 320 in use. The securing member 330 is shown demounted from the container 320.

A venting member 370 is provided for mounting to the mouth of the container 320, as is known for infant feeding bottle assemblies. The venting member 370 is secured on the container using the securing member 330.

The insert 371 includes a plurality of radial spokes and a series of apertures 379 therebetween. Each aperture extends through the insert 371 from a lower surface to an upper surface. The lower surface of the insert is adapted to be mounted to the mouth of the container. The upper surface of the insert 371 is an opposing surface to the lower surface so as to be oriented towards the nipple 340 in use.

The venting member 370 includes an air conduit communicating with the atmosphere through an inlet 373. The air conduit is formed within an insert 371, or body, of the venting member 370 which is mounted to the mouth of the container 320. In the example shown, the air conduit extends with one of the radial spokes. The air conduit extends radially inward from the inlet 373 through a radial spoke.

The spokes are arranged to radiate outward with equidistant spacing around the venting member 370. In this way, the series of apertures 379 form segments extending circumferentially around the insert 371. Each aperture 379 is suitably sized to permit substantially free-flow of fluid therethrough. In particular, each aperture 379 permits liquid from the container 320 to flow to the nipple 340 when feeding an infant, and permits steam generated in the container 320 during sterilisation to flow into the securing member 330 and nipple 340.

A tube 375 projects down from the insert 371 so that, when mounted to the container, the tube terminates at a distal end disposed close to the bottom of the container 320. The tube may be removably attached to the insert, or the tube and the insert may be formed as a single part.

In the upright position the container 320 is filled with liquid for feeding an infant. When the infant is feeding the container 320 is inverted so that the distal end of the tube 375 projects above the level of the liquid. An air flow path is thereby provided from the atmosphere through the inlet 371, air conduit, and tube 375, into the bottle such that pressure equalisation is provided when the infant drinks.

In the example shown, the venting member includes an air valve 377 mounted to the distal end of the tube 375 so as to control air passage through the venting member 370. In this way, the air valve 377 provides a one-way ingress of air into the container 320 without fluid in the container 320 leaking back into the venting member 370.

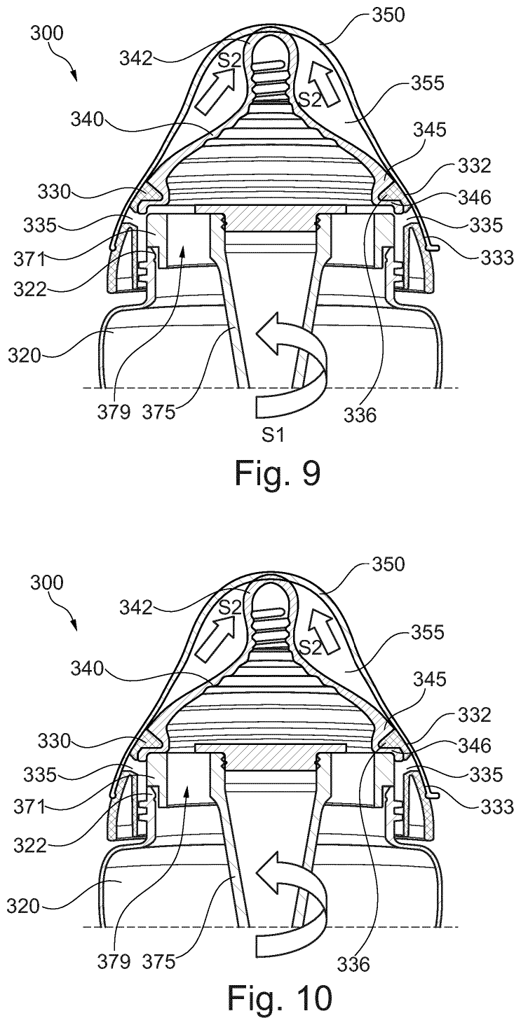

Referring now to FIG. 9, there is shown a cross-sectional view of infant feeding assembly 300 of FIG. 8 with its cover 350 mounted to the securing member 330. The assembly is shown in a first position. Thus, the venting member 370 is mounted to the mouth 322 of the container 320. The securing member 330 is arranged to mount the infant feeding nipple 340 to the container 320 so that a fluid flow path is provided between the container 320 and the surface 332. In particular, the fluid flow path extends through each aperture 379.

As with earlier examples, the cover 350 of the infant feeding assembly 300 is mounted to the cover contacting portion 333 so that the cover 350 encloses openings 335 provided on the surface 332. The cover 350 encloses the openings 335 without blocking the fluid flow path. In this way, with the cover 350 mounted to the securing member 330, a fluid flow path is provided from the mouth 322 of the container 320 to the internal recess 355 of the cover 350. The mouth 322 of the container 320 is thus fluidly connected to the internal recess 355 of the cover 350.

Also shown in FIG. 9, a radial projection 336 of the securing member 330 is matingly engaged in an annular recess of the nipple 340. The annular recess separates a sealing flange 346 of the nipple 340 from a nipple base portion 345. With the securing member 330 mounted to the nipple 340, a support surface engages the nipple base portion 345 to conveniently provides structural rigidity to the nipple base portion 345.

To sterilise the assembly, a user deposits water in the container 320 and generates steam from the water using a microwave oven as explained above in reference to FIG. 4.

The generated steam circulates within the container 320 and the venting member 370, as indicated by arrow S1. The steam flows through the series of apertures 379 to circulate in the internal cavity of the nipple 340. In this way, the steam sterilises all exposed surfaces within the assembly. That is the steam sterilises the internal surfaces of the securing member 330, nipple 340 and container 320, as well as surfaces of the venting member 370. Thus, the steam sterilises the surfaces of the infant feeding assembly 300 which are contactable by liquid stored or deposited in the assembly 300 prior to feeding.

As with other examples, the generated steam is conveyed by the fluid flow path from the container 320 to the internal recess 355 of the cover 350, as indicated by arrows S2. The steam is conveyed by the fluid flow path around the securing member 330 by the openings 335 of the cover 350.

The steam circulates within the internal recess 355. In this way, the steam sterilises exposed external surfaces of the nipple 340 and securing member 330. Thus, the steam sterilises the surfaces of the infant feeding assembly 300 which are contactable by the infant's mouth during feeding.

The steam also sterilises the inner surface of the cover 350, thereby ensuring the nipple 340 may be held in a sterile recess 355 for as long as the cover 350 remains mounted to the cover contacting portion 333.

When operation of the microwave oven ceases, the infant feeding assembly 300 may be allowed to cool until easily handled by a user.

The fluid flow path in the infant feeding assembly 300 is selectively closable. That is the fluid flow path may be closed so as to fluidly isolate the container 320 from the surface 332. The container 320 may be selectively fluidly isolated from the internal recess 355 of the cover 350.

As with other examples described herein, the infant feeding assembly 300 is adapted to be selectively moveable relative to the container 320 between the first position, in which the fluid flow path is open, and a second position, in which the fluid flow path is closed.

In particular, the infant feeding assembly 300 is rotatable relative to its container 320 due to the mating screw threads. Consequently, rotation of the infant feeding assembly 300 relative to its container 320 moves the infant feeding assembly 300 axially relative to container 320. In this way, rotation of the infant feeding assembly 300 in a first direction moves the infant feeding assembly to the second position.

Rotation brings the assembly into a sealing engagement of the venting member 370 with the mouth 322 of the container 320. Rotation also brings the assembly into a sealing engagement of the venting member 370 with a surface of the nipple 340. That is, rotation of securing member 330 urges the venting member 370 against the mouth 322 so that nipple 340 is fluidly connected to the container 320 and the fluid flow path is closed.

Referring now to FIG. 10, the assembly of FIG. 9 is shown in a second position. The infant feeding assembly 300 is sealingly engaged with the container 320 with the venting member 370 arranged in the mouth 322 of its container 320 and with the fluid flow path closed.

Selectively moving the infant feeding assembly 300 from the first position to the second position urges the infant feeding assembly 300 towards its container 320. In the example shown in FIG. 10, the infant feeding assembly 300 is arranged so that a sealing flange 346 of the nipple 340 is disposed on the underside of the securing member 330. In this way, moving the infant feeding assembly 300 from the first position to the second position urges the nipple 340 into sealing engagement with the venting member 370 in the mouth 322 of the container 320. The venting member 370 itself is thereby urged into sealing engagement with the mouth 322.

If the user is to store the infant feeding assembly 300 in a sterile, hygienic state then the assembly may be moved to the second position immediately after sterilisation is complete. Due to the position of the fluid flow path, the user can move the infant feeding assembly 300 to the second position by simply rotating the infant feeding assembly 300 relative to the container 320. Thus, the apparatus can be stored in a hygienic format without substantially reassembly, or without the user exposing or contacting the sterile surface 332.

When the infant feeding assembly 300 is to be used to feed a child, the user can demount the securing member 330, the nipple 340 and the cover 350 from the container 320 and deposit liquid into the container 320 in the usual manner.

It will be appreciated by persons skilled in the art that the above detailed examples have been described by way of example only and not in any limitative sense, and that various alterations and modifications are possible without departing from the scope of the invention as defined by the appended claims. Various modifications to the detailed examples described above are possible.

As will be apparent to the skilled person, the examples described herein may include an opening or the plurality of openings on the surface of the securing member may be provided in a number of different arrangements. The shape of the opening may be any suitable to convey steam from the mouth of the container. A plurality of openings distribute steam in a manner to ensure effective sterilisation of the exposed surfaces of infant feeding assembly.

Optionally, the fluid flow path may be provided in a number of ways. The fluid flow path may be formed in the nipple, or in a combination of the nipple and the securing member. For example, the fluid flow path may be formed as a channel along a surface of a least one of the securing member or the nipple. Thus, the fluid flow path may provided as a combination of features on both the nipple and the securing member.

Yet further, the fluid flow path may be provided at an interface between the nipple and the securing member. Preferably, the fluid flow path may be provided by an asymmetry between the nipple and the securing member at the interface between the two parts. That is within the interface portions of the nipple and the securing member may have surfaces which are non-complimentary. The non-complimentary portions thus provide a predetermined opening between the nipple and securing member.

Preferably, each fluid flow path arrangement may be selectively closable. That is the fluid flow path may be provided in one or both of the nipple or the securing member in a manner that is to selectively open or closed.

Optionally, the cover may include a locking mechanism so as to provide the cover with a releasable secondary engagement. For example, the cover may include a strap, cord or similar adapted to fasten to a member provided on the securing member or on the container. Or the strap, cord or similar may be provided on the container or the securing member adapted to provide suitable secondary engagement. In this way the reliability of the engagement between the cover and the infant feeding assembly may be further improved.

Optionally, the fluid flow path may be closed by other means, for example by an actuator operated by the user to selectively insert a closure within the fluid flow path.

1. A securing member for mounting an infant feeding nipple to a mouth of a container in an infant feeding assembly, the securing member comprising a surface having a cover contacting portion for selectively mounting a cover to the assembly;
wherein the securing member forms a fluid flow path configured such that, when the securing member mounts the infant feeding nipple to the container in use, the container is fluidly connected to the surface.

2. A securing member according to claim 1, wherein the fluid flow path is selectively closable.

3. A securing member according to claim 1, wherein the securing member is configured to be selectively moveable relative to the container between a first position, in which the fluid flow path is open, and a second position, in which the fluid flow path is closed.

4. A securing member according to claim 3, wherein, when in the second position, the assembly sealingly engages a mouth of the container.

5. A securing member according to claim 1, wherein the surface comprises an opening forming an outlet to the fluid flow path and, optionally, wherein the opening is an elongated slot.

6. A securing member according to claim 5, wherein the opening includes a plurality of openings arranged around the surface, the plurality of openings forming a plurality of outlets to the fluid flow path.

7. A securing member according to claim 1, wherein the securing member comprises a screw thread adapted to matingly engage a corresponding screw thread on the container.

8. An infant feeding assembly comprising a securing member according to claim 1, further comprising an infant feeding nipple mounted to the securing ring.

9. An infant feeding assembly according to claim 8, wherein the nipple comprises a feeding fluid flow path, wherein the feeding fluid flow path is provided through the nipple, and is configured to enable an infant to feed from the infant feeding assembly.

10. An infant feeding assembly according to claim 8, wherein the nipple is integrally formed with the securing member.

11. An infant feeding assembly comprising the securing member, according to claim 1, further comprising a cover mounted to the cover contacting portion and, optionally, comprising an infant feeding nipple enclosed by the cover.

12. An infant feeding assembly according to claim 11, wherein the cover comprises an internal recess, the internal recess defining a volume sufficient to receive at least a nipple of an infant feeding assembly.

13. An infant feeding assembly according to claim 12, wherein, when the cover is mounted to the cover contacting portion, the fluid flow path of the assembly is fluidly connected to the internal recess.

14. An infant feeding assembly comprising:
a securing member for mounting an infant feeding nipple to the assembly, the securing member comprising a cover contacting portion;
a cover mounted to the cover contacting portion, the cover comprising an internal recess for receiving the infant feeding nipple and a spacer member for selectively mounting the assembly to a container;
wherein the assembly forms a fluid flow path configured such that, when the spacer member mounts the assembly to a container, the container is fluidly connected to the internal recess.

15. An infant feeding assembly according to claim 14, wherein the securing member is adapted to be selectively moveable relative to the container between a first position, in which the fluid flow path is open, and a second position, in which the fluid flow path is closed.

16. An infant feeding assembly according to claim 15 wherein, in the second position, the securing member mounts the assembly to the container.

17. An infant feeding assembly according to claim 14, wherein a portion of the fluid flow path is formed in at least one of the securing member, the cover or the nipple.

18. An infant feeding assembly according to claim 14, wherein a portion of the fluid flow path is provided as a channel along a surface of at least one of the securing member, the cover or the nipple.

19. An infant feeding assembly according to claim 14, wherein a portion of the fluid flow path is provided as a conduit extending though at least one of the securing member, the cover or the nipple.

20. An infant feeding assembly according to claim 14 further comprising a container mounted to the securing member.

21. (canceled)

22. (canceled)

23. (canceled)

24. (canceled)

25. A method of sterilising an infant feeding bottle, the method comprising the steps of:
providing an infant feeding assembly, the assembly comprising:
a securing member for mounting an infant feeding nipple to a mouth of a container;
a surface comprising a cover contacting portion for selectively mounting a cover to the assembly; and
a flow path between an inner surface portion of the securing member and the surface;
mounting an infant feeding nipple to a mouth of a container;
mounting a cover on the cover contacting portion including an internal recess so that the nipple is received into the internal recess;
generating steam within the container so as to convey the steam from the mouth of the container to the internal recess via the flow path.
